(19) United States
(12) Patent Application Publication
(10) Pub. No.: US 2013/0044847 A1
(43) Pub. Date: Feb. 21, 2013

(54) Apparatus and Method for Low Energy Nuclear Reactions

(71) Applicant: Dan Steinberg, Blacksburg, VA (US)

(72) Inventor: Dan Steinberg, Blacksburg, VA (US)

(21) Appl. No.: 13/545,983

(22) Filed: Jul. 11, 2012

Related U.S. Application Data
(60) Provisional application No. 61/572,142, filed on Jul. 12, 2011.

(51) Int. Cl. H05H 6/00

(52) U.S. Cl. 376/151

(57) ABSTRACT

Provided are a method and apparatus for low energy nuclear reactions in hydrogen-loaded metals. A nickel cathode is disposed inside a pressure vessel loaded with heavy water. The vessel is heated to a temperature at which nickel oxide is reduced in the presence of hydrogen. The cathode is electrified, thereby producing hydrogen at the cathode, which removes any oxide layer on the nickel. The nickel can therefore more easily be loaded with hydrogen. The nickel cathode preferably has embedded particles of neutron-absorbing and/or hydrogen absorbing materials, such as boron-10, lithium-containing compounds, palladium, niobium, vanadium, or other hydrogen storage intermetallic compounds, alloys, or amorphous alloys.

### RELATED APPLICATIONS

The present application claims the benefit of priority from provisional patent application 61/572,142 filed on Jul. 12, 2011, which is hereby incorporated by reference.

### FIELD OF THE INVENTION

The present invention relates generally to low energy nuclear reaction (LENR) phenomena, anomalous excess heat research and energy generation.

### BACKGROUND OF THE INVENTION

Low energy nuclear reaction (LENR) phenomena have been investigated for over 20 years. Many researchers have observed anomalous excess heat, high-energy particle production, and nuclear transmutation in metals containing high concentrations of hydrogen or deuterium. The LENR research field is controversial, with several different theories to explain these observations.

One theory of LENR advocated by Dr Hagelstein of MIT holds that energy production in deuterium-loaded metals is the result of D+D fusion. The absence of gamma radiation is the result of excitation transfer, in which a single high energy particle (e.g. gamma particle) is split into a large number of low energy particles (e.g. infrared photons or phonons). Some LENR experiments are consistent with this theory in that the amount of excess energy observed and amount of He-4 generated are approximately equal to the amount expected from the 23.85 MeV released in each D+D reaction.

The Bose-Einstein condensate theory of deuterium fusion in deuterium-loaded metals holds that D+D fusion occurs as a result of the deuterons forming a Bose-Einstein condensate. The condensates occur in metal grains/nanoparticles in the metal lattice. The distributed wavefunction of the BE condensate results in the energy of fusion reactions (23.85 MeV per D+D fusion) being transferred to the metal lattice in a distributed form, such as a large number of phonon lattice vibrations.

The Widom-Larsen (WL) theory of LENR holds that LENR reactions occur as a result of ultra-low momentum neutron production. Specifically, according to the WL theory, the surface of a deuterium (or hydrogen)-loaded metal acquires a layer of collectively oscillating protons or deuterons. These protons or deuterons capture electrons by the weak interaction, thereby forming neutrons with exceptionally low momentum. The low momentum neutrons have a very high absorption cross section, and are therefore rapidly and completely absorbed by nearby atomic nuclei. Absorption by lithium or boron-10 nuclei will produce high energy beta particles and He-4. See for example U.S. Pat. No. 7,893,414.

Each these theories of LENR have some experimental support. It is not possible at this time to determine which theory, if any, or which combinations, is correct.

Low energy nuclear reactions may provide a useful new source of energy. However, the energy production in existing devices is too small to be of practical use for energy production. Also, existing devices operate at temperatures too low to be used as a heat source for a heat engine (e.g. steam turbine). Consequently, there is a great need for improved devices and methods for creating energy from hydrogen and deuterium-loaded metals.

### SUMMARY

An apparatus and method for low energy nuclear reactions. The present apparatus includes a pressure vessel containing a cathode having a nickel surface. The vessel also contains water (e.g. deuterium oxide). The cathode is heated to a temperature at which nickel oxide is reduced by contact with hydrogen, such as 200 C or higher. Hydrogen exposure removes nickel oxide from the surface, thereby facilitating high deuterium loading of the nickel.

In some embodiments, particles are embedded in the nickel. The particles can be made of a material that reacts with low energy neutrons according to WL theory (e.g. boron-10 or lithium-containing compounds). The particles can also be made of materials with a high hydrogen storage capability and reactivity with hydrogen, such as palladium, niobium, amorphous alloys for example.

### DESCRIPTION OF THE FIGURES

FIG. 1 shows a reactor according to the present invention.

FIG. 2 shows a nickel-coated cathode according to the present invention.

FIG. 3 shows a composite nickel cathode according to the present invention.

FIG. 4 shows a reactor having two temperature zones according to the present invention.

### DETAILED DESCRIPTION

The present invention provides an apparatus and method for performing low energy nuclear reactions in hydrogen or deuterium-loaded metals. The apparatus comprises a pressure vessel capable of containing liquid water at temperatures of at least 200 C. An anode and cathode are disposed in the water, and are electrically connected to the exterior of the vessel. The cathode comprises a nickel coating, and the nickel coating preferably contains at least one or more particulate inclusions for enhancing the reactions (e.g. boron-10, niobium, palladium, lithium-containing ceramics, tantalum or vanadium). The nickel coating can also comprise a nickel-boron alloy. In operation, hydrogen is reduced at the cathode. Any nickel oxide at the cathode surface is reduced to nickel metal, thereby removing a barrier to loading of the cathode and nickel coating with hydrogen or deuterium. The particles embedded in the nickel coating are consequently exposed to an increased pressure of loaded hydrogen or deuterium.

### DEFINITIONS

Hydrogen: Can refer to hydrogen with a single neutron or two neutrons (deuterium).

FIG. 1 shows an apparatus according to the present invention. The apparatus comprises a pressure vessel 20 containing heavy water (deuterium oxide) 23 at high temperature and pressure (e.g. 350 C and 2500PSI). The vessel includes a headspace 24 containing water vapor, released hydrogen and oxygen, and optionally, inert gases such as argon. A hydrogen oxidation catalyst 26 is disposed in the headspace 24 and in contact with any hydrogen and oxygen present in the headspace 24. Electrical feedthroughs 22a 22b provide electrical connections between an electrical power supply 28 external to the vessel 20 with a cathode 30 and anode 32 inside the vessel. Cathode 30 necessarily has a nickel surface. Cathode 30 can be made of solid nickel, or can include a nickel coating 34 on surface. Cathode 30 interior can be made of nickel or many other metals.

In operation, electrical current from the supply 28 flows into the cathode 30 and anode 32 and through the heavy water 23. Hydrogen gas 36 forms at the cathode, and oxygen gas 38 forms at the anode 32. The cathode becomes highly loaded, and LENR phenomena occur at the cathode only.

Though bubbles are illustrated in FIG. 1, bubbles may not be created in some embodiments of the present invention. Hydrogen 36 and oxygen 38 are recombined at the oxidation catalyst 26 to form water vapor.

Significantly, in the present invention, the hydrogen gas 36 formed at the cathode surface reduces any nickel oxides that may be present at the surface of the cathode 30 or nickel coating 34. The reaction between nickel oxide and hydrogen occurs only at elevated temperature, such as above about 150 C or 200 C. Preferably, the present apparatus is operated at temperatures of at least about 150 C 175 C or 200 C. Preferably, the temperature is at least about 200 C, the temperature at which the reaction between nickel oxide and hydrogen occurs at a reasonable rate. It is noted that only the water 22 and cathode 30 need to be at the high temperature. Other components of the apparatus can be kept at lower temperature.

The reduction of surface nickel oxide is important because nickel oxide is a severe barrier to hydrogen loading. An oxide coating tends to prevent the flow of hydrogen nuclei (protons, deuterons) from the water 23 into the nickel metal, which is highly undesirable. The cathode 30 necessarily has a nickel surface, and the apparatus is operated at elevated temperature at which nickel oxide is reduced by hydrogen. Consequently, the bare-nickel cathode surface presents a minimal barrier to hydrogen loading, enabling rapid and high loading of the cathode. This is highly desirable for producing low energy nuclear reactions.

The pressure vessel 20 can be made of many different materials, such as stainless steels, nickel superalloys and the like. It can be designed to operate at temperatures typical of conventional boilers, such as about 200 C-600 C (about 400 F-1100 F). Pressures can be about 2000-3000 PSI, for example. At temperatures above the critical point (374 C), there will be no distinct liquid and gas phases. However, electrical current will be able to flow between the cathode and anode provided that the water has sufficient density.

An interior surface of the pressure vessel may be lined with a nonconductive material such as glass or ceramic to protect the vessel from electrochemical corrosion.

The feedthroughs 22a 22b can be disposed in a relatively cooler area of the vessel to facilitate effective seals.

The oxidation catalyst 26 can be made of platinum deposited on a ceramic substrate, for example. Combustion catalysts are well known in the art.

The anode 32 can be made of many different materials such as nickel, passivated nickel (e.g. oxide passivated or fluoride passivated), graphite, silicon carbide, doped silicon carbide, doped diamond, silicon, precious metals (e.g. platinum, palladium), conductive ceramics and the like. Preferably, the anode is made of a electrically conductive material that has high resistance to oxidation and erosion at elevated temperature and will not produce harmful contamination of the cathode surface.

The electrical power supply 28 can be a direct current (DC) power supply, or can produce DC power with an alternating current (AC) component. The power supply 28 can provide continuous or pulsed voltage. In the field of LENR, many different electrical power waveforms for loading the cathode are known in the art. The present invention and claims are not limited to any particular scheme or method for applying electrical potential to the cathode 30 and anode 32.

The water 23 is preferably heavy water comprising high purity deuterium oxide. Preferably, the purity is at least 99%, such as 99.8% which is commonly available. The purity can also be 99.99% or higher.

The water 23 can optionally contain an electrolyte. If an electrolyte is used, preferably, the electrolyte contains lithium ions. For example, lithium metaborate can be used. Lithium has a high ionic conductivity in water and is therefore preferred for many LENR experiments. According to the WL theory lithium reacts with some low momentum neutrons to release energy.

Optionally, the water 23 does not contain an added electrolyte. In this case, the water may contain only contaminant ions from the pressure vessel 20 and other components inside the vessel (cathode 30, anode 32, catalyst 25, feedthroughs 22a 22b). Alternatively, the water is deionized, and can be actively deionized in a continuous, ongoing matter while the apparatus is operating. The high temperature of the water dramatically increases its ionic conductivity, thereby facilitating current flow. Also, an absence of added electrolyte tends to increase the potential difference at the cathode surface, which is believed to increase loading of the cathode metal.

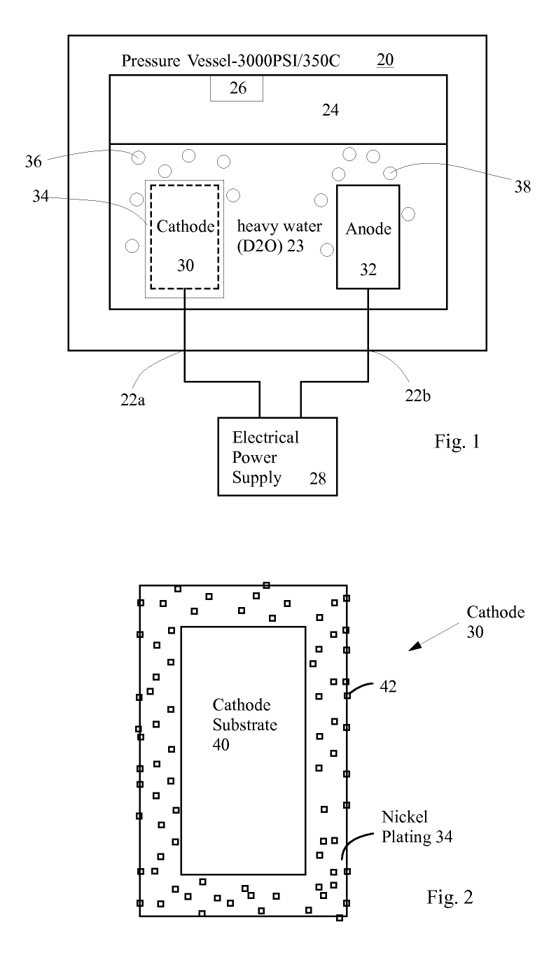

FIG. 2 shows a closeup view of a cathode 30 according to a preferred embodiment of the present invention. The cathode 30 comprises a nickel coating 34 disposed on a cathode substrate 40. The nickel coating can be an electrodeposited coating, an electrolessly deposited coating, or a vapor deposited coating (evaporation, sputtering). The coating can have a wide range of thicknesses and physical properties (hardness, stress etc). The substrate 40 can be made of nickel, other metals, ceramic or other heat-resistant material.

The nickel coating 34 preferably has embedded particles 42. The particles can have sizes ranging from nanoscale (e.g. 10-1000 nm) to micron-scale (e.g. 1-50 microns). In one embodiment, the particles are about 325 mesh.

The particles can be embedded in the nickel by a composite electroplating process, in which the particles are mixed into an electroplating solution, while the nickel is electrodeposited. In this method, the particles are co-deposited with the nickel and become embedded in the nickel. Composite electroplating is well known in the art.

The particles can be embedded in the nickel by other processes. For example, particles can be dusted onto the substrate before or during physical vapor deposition or sputtering in vacuum. Alternatively, the particles can be mixed into nickel power, and fused by heat and compression (composite powder metallurgy).

The particles can be made of many materials.

For example, the particles can be made of boron-10, or naturally-occurring boron (naturally occurring boron contains about 20% boron-10). Boron is a preferred material because it has a very large neutron-capture cross section, and when boron-10 captures a low momentum neutron (present in WL theory), it releases large amounts of energy. The boron-10 can be in the form of pure boron, or in the form of boron compounds, such as boron oxide, boron-containing ceramics, or the like.

The particles can also be made of non-water soluble, lithium-containing ceramics or compounds. Lithium is too chemically reactive to use in metallic form, so it should be used as a stable compound. Lithium releases energy when neutrons are absorbed, according to WL theory. Suitable lithium compounds include lithium niobate, lithium oxide, lithium silicate or the like.

The cathode can contain a combination of neutron-absorbing particles (e.g. boron-10 or lithium) and particles that can be loaded with large amounts of hydrogen.

An exemplary material for hydrogen loading is palladium, a material known for producing LENR phenomena. The palladium particles can be nanoscale (palladium black), or micron-scale for example.

In a preferred embodiment, at least some of the particles are made of a material with a hydrogen loading capacity. Preferably, the loading capacity is such that the maximum achievable H/M atomic ratio is greater than 1.

Niobium, vanadium, titanium and zirconium for example have a high hydrogen loading capacity. These materials tend to become brittle when highly loaded with hydrogen, so it is difficult or impossible to load a cathode made of solid niobium, vanadium, or titanium. The cathode will often crack and break because of the embrittlement. By using these materials in particle form embedded in nickel, a material that experiences less embrittlement during loading, cracking and breaking of the cathode is reduced.

It is noted that in embodiments where the reactive metals (niobium, vanadium or titanium) are embedded in the nickel using an aqueous process the particles will have an oxide coating. To avoid this, the reactive metal particles can be fully reduced in an inert atmosphere and mixed with nickel metal power, and then pressed. This will form a composite material in which the particles do not have an oxide layer separating them from the nickel. This will facilitate hydrogen loading of the particles. Alternatively, electroplating can be performed in an oxygen-free environment with a solvent that does not react with the metal particles, such as an ionic liquid.

The particles can also be made of metal alloys or intermetallic compounds that have a high hydrogen storage capability. Preferably the hydrogen storage ratio H/M is greater than or equal than 1. Exemplary materials include V—Ni alloys, transition metal/rare earth metal intermetallic compounds such as LaNi5, Nb3Al, V3Ga, Ti2Co, and La3In. Additional materials that can be used for the particles are described in international patent publication WO 91/06959, published on May 16, 1991, which is hereby incorporated by reference.

The particles can also be made of metallic glass materials (amorphous alloys) that have a high hydrogen loading capacity (e.g. a loading capacity with H/M atomic ratio greater than 1.0). Such metallic glasses include Zr—Cu—Ni—Al metallic glasses (e.g. Zr69.5Cu12Ni11Al7.5).

The particles can comprise mixtures of different types of particles. For example, both boron-10 and palladium particles can be embedded in the nickel matrix. Or both boron-10, lithium-containing particles and niobium particles can be embedded in the nickel matrix.

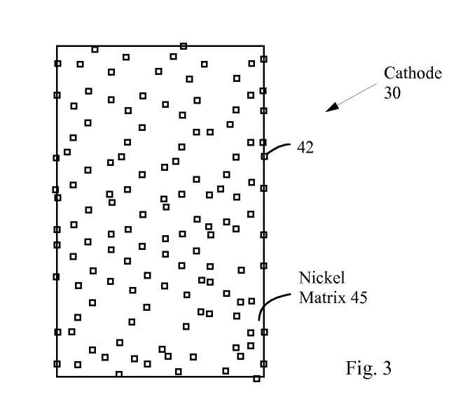

FIG. 3 shows an embodiment of the cathode in which the entire cathode is made of a composite material comprising a nickel matrix 45 and the embedded particles 42. This embodiment does not have a cathode substrate. The cathode according to this embodiment can be made by composite powder metallurgical process, in which powders of nickel and desired particle material (e.g. boron-10, palladium, niobium etc) are mixed and then pressed into a dense, monolithic material.

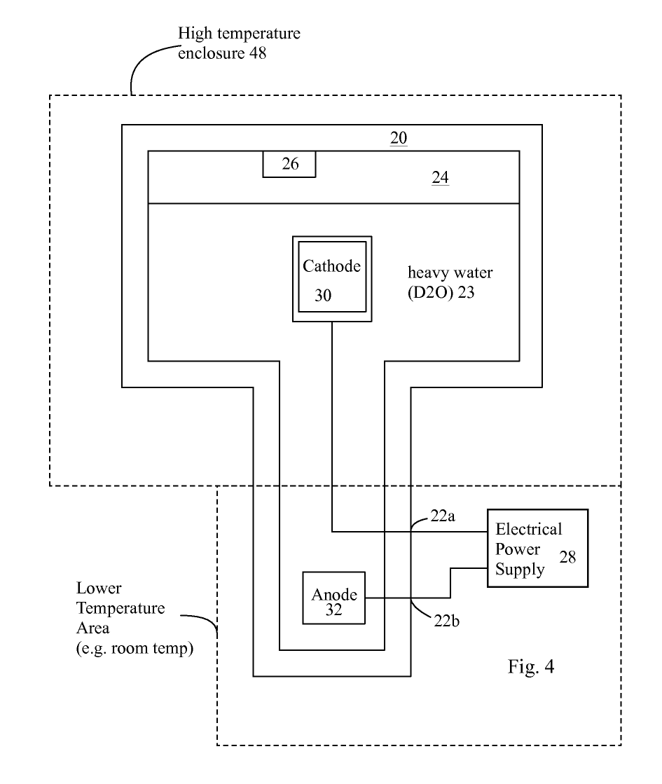

FIG. 4 shows an embodiment in which only the cathode 30 and catalyst 26 are at high temperature, and the anode 32 and electrical feedthroughs 22a 22b are at a lower temperature. A high temperature enclosure 48 surrounds the area of the pressure vessel containing the cathode 30 and catalyst 26. This arrangement is beneficial because it can reduce oxidation and corrosion of the anode 32. For example, if the anode 32 is made of graphite, it can be oxidized by oxygen if it is at high temperature. The heat temperature enclosure can be an oven. The enclosure 48 can be the heat input to a heat engine in applications where the LENR reactor is used to produce energy.

The above embodiments may be altered in many ways without departing from the scope of the invention. Accordingly, the scope of the invention should be determined by the following claims and their legal equivalents.

What is claimed is:

1. A method for creating low energy nuclear reactions or anomalous energy-releasing reactions, comprising the steps of:
1) enclosing deuterium oxide inside a pressure vessel containing an anode and a cathode with at least one nickel surface;
2) electrically connecting the cathode and anode to an electrical power supply external to the pressure vessel;
3) heating the cathode to a temperature at which nickel oxide is reduced by contact with hydrogen;
4) electrifying the cathode such that the deuterium oxide is reduced at the cathode, forming hydrogen, whereby surface nickel oxide at the cathode is reduced to nickel metal;
5) sustaining step (4) such that the cathode becomes loaded with deuterium.

2. The method of claim 1 wherein the cathode is heated to a temperature of at least 150 C.

3. The method of claim 1 wherein the cathode is heated to a temperature of at least 200 C.

4. The method of claim 1 further comprising the step of embedding in the nickel surface particles made of a material selected from the group consisting of boron, boron-10, lithium-containing compounds, palladium, niobium, vanadium, titanium, and alloys thereof.

5. The method of claim 1 further comprising the step of embedding in the nickel surface particles made of a material selected from the group consisting of metallic glasses, Zr—Cu—Al—Ni metallic glasses, Zr—Ti—Cu—Ni metallic glasses, Zr—Cu—Ni—Ti—Al metallic glasses, Zr—Cu—Ni—Nb—Al metallic glasses.

6. The method of claim 1 further comprising the step of embedding in the nickel surface particles made of a material capable of hydrogen loading to a H/M atomic ratio greater than 1.

7. An apparatus for low energy nuclear reactions, comprising:
a) a pressure vessel capable of containing liquid water at a temperature of at least 200 C;
b) at least two electrical feedthroughs extending between an interior and an exterior of the vessel;
c) an anode connected to one electrical feedthrough and capable of contacting the water;
d) a cathode connected to one electrical feedthrough and capable of contacting the water,
wherein the cathode has at least one surface comprising nickel, and wherein the nickel surface does not have a surface oxide layer.

8. The apparatus of claim 7 wherein the cathode comprises a nickel coating.

9. The apparatus of claim 7 wherein particles are embedded in the nickel, and the particles are made of a material selected from the group consisting of boron, boron-10, lithium-containing compounds, palladium, niobium, vanadium, titanium, and alloys thereof.

10. The apparatus of claim 7 wherein particles are embedded in the nickel, and the particles are made of a material selected from the group consisting of metallic glasses, Zr—Cu—Al—Ni metallic glasses, Zr—Ti—Cu—Ni metallic glasses, Zr—Cu—Ni—Ti—Al metallic glasses, Zr—Cu—Ni—Nb—Al metallic glasses.

11. The apparatus of claim 7 wherein particles are embedded in the nickel, and the particles are made of an transition metal/rare earth metal intermetallic compound.

12. The apparatus of claim 7 wherein particles are embedded in the nickel, and the particles are made of a material capable of hydrogen loading to a H/M atomic ratio greater than 1.

13. The apparatus of claim 7 wherein the water is deuterium oxide with a purity of at least 98%.
